(19) United States
(12) Patent Application Publication
(10) Pub. No.: US 2026/0149313 A1
(43) Pub. Date: May 28, 2026

(54) OPTICAL WIRELESS POWER TRANSMISSION SYSTEM, RECEPTION APPARATUS, TRANSMISSION APPARATUS, CONTROL APPARATUS, CONTROL METHOD, AND PROGRAM

(71) Applicant: NTT, Inc., Tokyo (JP)

(72) Inventors: Natsuha OCHIAI, Tokyo (JP); Toru TANAKA, Tokyo (JP); Yohei TORIUMI, Tokyo (JP)

(21) Appl. No.: 19/120,432

(22) PCT Filed: Nov. 10, 2022
(86) PCT No.: PCT/JP2022/041907

§ 371 Date: Apr. 11, 2025

(51) Int. Cl. H02J 50/30; H02J 50/40

(52) U.S. Cl. CPC H02J 50/30; H02J 50/402

(57) ABSTRACT

An optical wireless power supply system includes a light source unit including a plurality of light source elements, and a photoelectric conversion unit including a plurality of photoelectric conversion elements, in which a light emitting surface of the light source unit and a light receiving surface of the photoelectric conversion unit are arranged to face each other. An arrangement of the plurality of photoelectric conversion elements on the light receiving surface is the same as an arrangement of the plurality of light source elements on the light emitting surface.

### TECHNICAL FIELD

The present invention relates to an optical wireless power supply technology.

### BACKGROUND ART

In the optical wireless power supply technology, for example, a laser is used as an energy medium. Laser light (also referred to as a laser beam) is transmitted from a laser toward a power supply target, and the laser light is converted into power using a photoelectric conversion element such as a solar cell at the power supply target. Here, a light source (light source element) that outputs laser light is referred to as a “laser”. A “laser” may be referred to as a laser medium, a laser oscillator, or the like.

### CITATION LIST

### Non-Patent Literature

Non-Patent Literature 1:“Basics and Applications of Solar Cell Utilization”, CQ Publishing, P53

### SUMMARY OF INVENTION

### Technical Problem

In an optical wireless power supply technology, in order to supply sufficient power to the power supply target, it is expected that a multi-cell type photoelectric conversion unit having a configuration in which a plurality of cells (photoelectric conversion elements) is connected will be used on the receiving side of the laser light. However, in the related art, in a case where a multi-cell type of photoelectric conversion unit is used, there is a problem that it is not possible to efficiently extract power from light.

The present invention has been made in consideration of the above-mentioned points, and an object of the present invention is to provide a technology that enables efficient extraction of power from light in an optical wireless power supply technology.

### Solution to Problem

According to the disclosed technology, there is provided an optical wireless power supply system including:
a light source unit including a plurality of light source elements; and
a photoelectric conversion unit including a plurality of photoelectric conversion elements,
in which a light emitting surface of the light source unit and a light receiving surface of the photoelectric conversion unit are arranged to face each other, and an arrangement of the plurality of photoelectric conversion elements on the light receiving surface is the same as an arrangement of the plurality of light source elements on the light emitting surface.

### Advantageous Effects of Invention

According to the disclosed technology, it is possible to provide a technology that enables efficient extraction of power from light in an optical wireless power supply technology.

### BRIEF DESCRIPTION OF THE DRAWINGS

FIG. 1 is a diagram for describing a problem.

FIG. 2 is a diagram for describing a problem.

FIG. 3 is a configuration diagram illustrating an optical wireless power supply system according to an embodiment of the present invention.

FIG. 4 is a configuration diagram of a transmission apparatus 100.

FIG. 5 is a configuration diagram of a reception apparatus 200.

FIG. 6 is a diagram illustrating an example of cell arrangement.

FIG. 7 is a configuration diagram of a control apparatus 300.

FIG. 8 is a diagram for describing an operation of the optical wireless power supply system.

FIG. 9 is a diagram for describing cell numbering.

FIG. 10 is a diagram for describing laser numbering.

FIG. 11 is a diagram for describing an operation of the optical wireless power supply system.

FIG. 12 is a diagram for describing an operation of the optical wireless power supply system.

FIG. 13 is a configuration diagram of a photoelectric conversion unit 210.

FIG. 14 is a configuration diagram of the photoelectric conversion unit 210.

FIG. 15 is a flowchart illustrating an operation example of the control apparatus 300.

FIG. 16 is a diagram illustrating an example of a hardware configuration of an apparatus.

### DESCRIPTION OF EMBODIMENTS

An embodiment of the present invention (present embodiment) will be described below with reference to the drawings. The embodiment to be described below is merely an example, and embodiments to which the present invention is applied are not limited to the embodiment to be described below.

In the embodiment described below, it is assumed that a laser is used as a light source in a transmission apparatus; however, using a laser as the light source is merely one example. The light source to which the technology according to the present invention can be applied is not limited to a specific type of light source. Any light source may be used as long as it is capable of emitting light (electromagnetic waves ranging from infrared to ultraviolet). Hereinafter, the entity that outputs light may be referred to as a “light source element” or a “light source unit”. As described above, the light source is not limited to a laser, but in the present embodiment, it is preferable to use a laser as the light source.

In the following, first, the problems associated with the technology of the present embodiment will be described in detail, and then the technology of the present embodiment will be described. Note that the contents of the description of the following problems are not publicly known.

### Problems

Generally, a beam (which may also be referred to as a light beam, a beam of light, etc.) output from a laser is referred to as a Gaussian beam, and the light intensity distribution in a plane perpendicular to the optical axis is a Gaussian distribution.

In an optical wireless power supply technology, there are two types of photoelectric conversion units that convert received light into electricity: a single-cell type that has only one cell, which is a photoelectric conversion element, and a multi-cell type that has a plurality of cells. The voltage that can be extracted from one cell is determined by the size of the band gap of the element, and is 0.5 V for a typical solar cell (Non-Patent Literature 1). Therefore, when attempting to supply high power, the current value becomes large, making the single-cell type unsuitable.

On the other hand, in the case of a multi-cell type, by connecting the cells in series, the voltage can be increased, and the power that can be extracted can be increased. However, if there is a cell that is not sufficiently irradiated with light among the plurality of cells, the current value of the cell becomes a bottleneck, and the entire current value is limited, so that a large amount of power cannot be obtained. Furthermore, the light energy incident on the other cells cannot be extracted as power, but turns into heat, which deteriorates the characteristics of the photoelectric conversion unit.

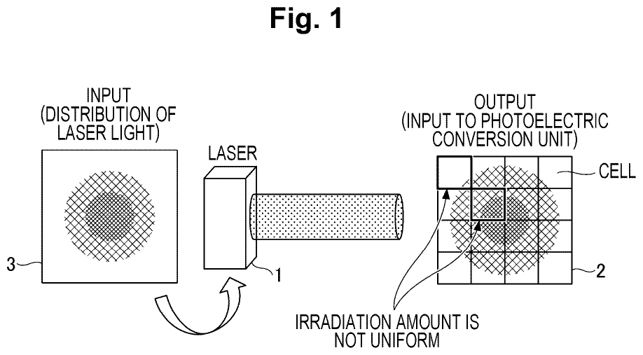

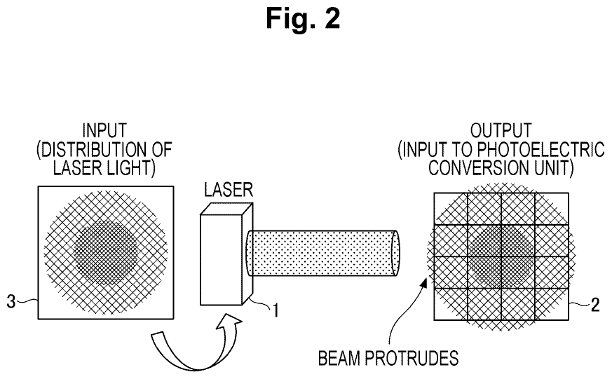

The above-described problems in the case of using a Gaussian beam will be described more specifically with reference to FIGS. 1 and 2.

In the configuration illustrated in FIGS. 1 and 2, a laser 1 as a light source element and a photoelectric conversion unit 2 on a light receiving side are illustrated. For the laser 1, a surface 3 (light emitting surface) on a side on which the laser 1 outputs light is also illustrated. In addition, for the photoelectric conversion unit 2, a surface (light receiving surface) on a side receiving light is illustrated. As illustrated in FIGS. 1 and 2, the photoelectric conversion unit 2 includes a plurality of cells in a lattice pattern. In FIGS. 1 and 2, since the beam output from the surface 3 is input into the optical path, it is described as “input” on the surface 3. Further, the output from the optical path becomes the input to the photoelectric conversion unit 2.

As described above, since the intensity distribution of the Gaussian beam is a Gaussian distribution, it is difficult to uniformly apply light to each cell constituting the photoelectric conversion unit 2 as illustrated in FIG. 1. Note that, in the drawings of the present application, the shape (light intensity distribution) of the Gaussian beam on the light emitting surface or the light receiving surface is shown as an image rather than an actual intensity distribution for convenience of illustration. In the Gaussian beam, according to the Gaussian distribution, in the circular shape, the light at the central portion is strong, and the light becomes weaker toward the periphery.

In addition, as illustrated in FIG. 2, in a case where the laser 1 that outputs laser light (beam) from a wider area is used in order to uniformly apply light to each cell as much as possible, the beam protrudes from the light receiving surface of the photoelectric conversion unit 2, and an increase in loss and a problem of safety occur. In addition, it is expected that an atmospheric turbulence will disturb the beam, and further bias the intensity distribution.

An atmospheric turbulence is disturbance of air in the atmosphere. A refractive index distribution is generated by vortices of air of various sizes, and when light such as laser light propagates in the atmosphere, a wave front is disturbed.

Hereinafter, a configuration and an operation of a system for solving the above-described problems will be described in detail.

### Example of System Configuration

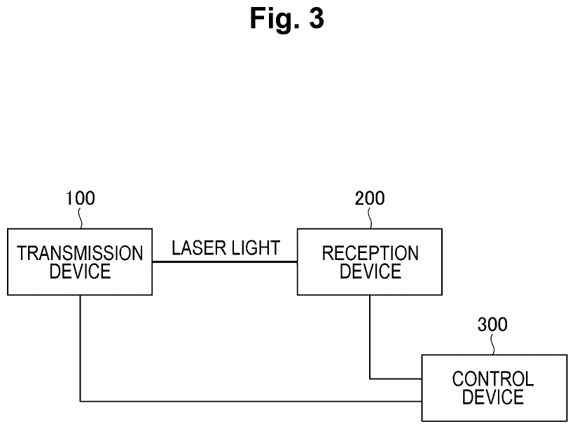

FIG. 3 illustrates a configuration example of an optical wireless power supply system according to the present embodiment. As illustrated in FIG. 3, the optical wireless power supply system according to the present embodiment includes a transmission apparatus 100, a reception apparatus 200, and a control apparatus 300. The transmission apparatus 100 and the reception apparatus 200 are each capable of communicating with the control apparatus 300. Furthermore, the transmission apparatus 100 and the reception apparatus 200 may each be connected to the control apparatus 300 in a wired manner or in a wireless manner. Furthermore, the control apparatus 300 may be provided in the reception apparatus 200.

### Example of Configuration of Each Apparatus

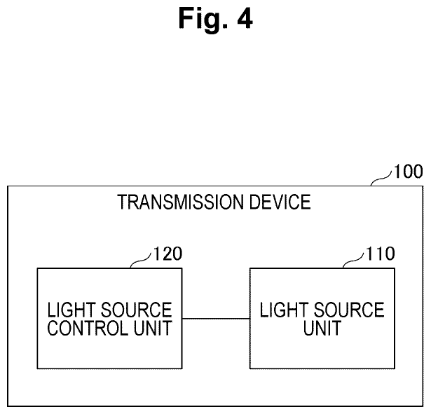

FIG. 4 illustrates an example of the configuration of the transmission apparatus 100. As illustrated in FIG. 4, the transmission apparatus 100 includes a light source unit 110 and a light source control unit 120. In the present embodiment, the light source unit 110 includes a structure in which a plurality of lasers (light source elements) is arranged in an array (which may be expressed as a lattice pattern). The light source unit 110 may be referred to as an array of lasers, a laser array, or the like.

The light source control unit 120 controls the output of each laser in the light source unit 110 (laser array) on the basis of an instruction (control signal) from the control apparatus 300. That is, the intensity of the laser light to be output is increased or decreased.

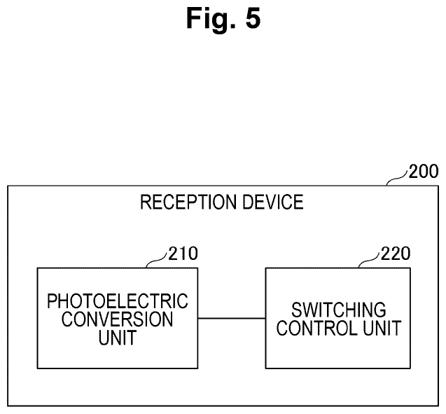

FIG. 5 illustrates an example of the configuration of the reception apparatus 200. As illustrated in FIG. 5, the reception apparatus 200 includes a photoelectric conversion unit 210 and a switching control unit 220. The photoelectric conversion unit 210 has a configuration in which a plurality of photoelectric conversion elements (each photoelectric conversion element is referred to as a cell) is arranged in a lattice pattern.

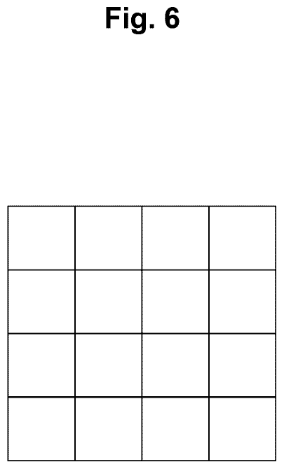

FIG. 6 illustrates an example of cell arrangement in a case where the light receiving surface of the photoelectric conversion unit 210 is viewed from the output side of the laser light. Each square in FIG. 6 is a cell. Note that arranging a plurality of cells in a lattice pattern is an example, and a configuration in which a plurality of cells is arranged in a form other than a lattice pattern may be employed.

The switching control unit 220 changes (switches) the connection state of the cells in the photoelectric conversion unit 210 on the basis of an instruction (control signal) from the control apparatus 300.

Note that the functional unit (device) to which the power obtained by the photoelectric conversion unit 210 is supplied may be provided in the reception apparatus 200 or may be provided outside the reception apparatus 200.

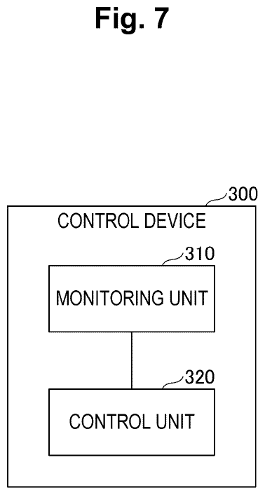

FIG. 7 illustrates an example of the configuration of the control apparatus 300. As illustrated in FIG. 7, the control apparatus 300 includes a monitoring unit 310 and a control unit 320.

The monitoring unit 310 monitors the voltage of each cell in the photoelectric conversion unit 210. The control unit 320 controls the output of the laser in the transmission apparatus 100 or changes the connection state of the cell in the reception apparatus 200 on the basis of the monitoring result from the monitoring unit 310.

### Operation Example of System

An operation example of the optical wireless power supply system having the above-described configuration will be described. Here, the light emitting surface of the light source unit 110 and the light receiving surface of the photoelectric conversion unit 210 are arranged to face each other. In addition, the arrangement of the lasers of the laser array as the light source unit 110 is the same as the arrangement of the cells in the photoelectric conversion unit 210.

For example, the arrangement of the lasers of the laser array is the arrangement illustrated in FIG. 6 illustrating the cell arrangement. Assuming that FIG. 6 illustrates a laser array, each square indicates a location (position) where each laser is arranged. A plurality of cells (photoelectric conversion elements) constituting the photoelectric conversion unit 210 is electrically connected in series.

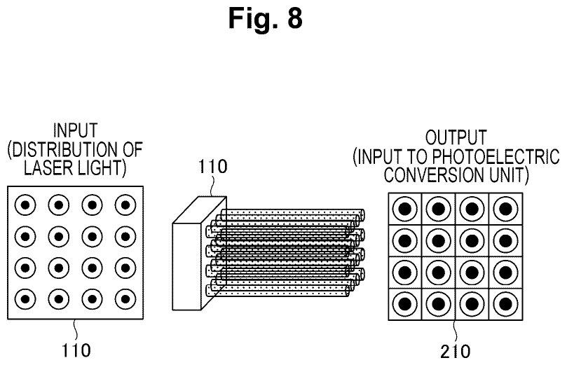

FIG. 8 illustrates an image in a case where laser light is transmitted from the light source unit 110 (laser array) to the photoelectric conversion unit 210. As for the light source unit 110 (laser array), a light emitting surface on a side that outputs light is also illustrated. Furthermore, as for the photoelectric conversion unit 210, a light receiving surface on a side that receives (receives) light is illustrated.

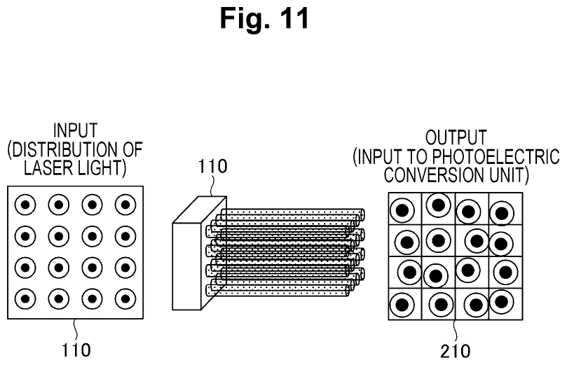

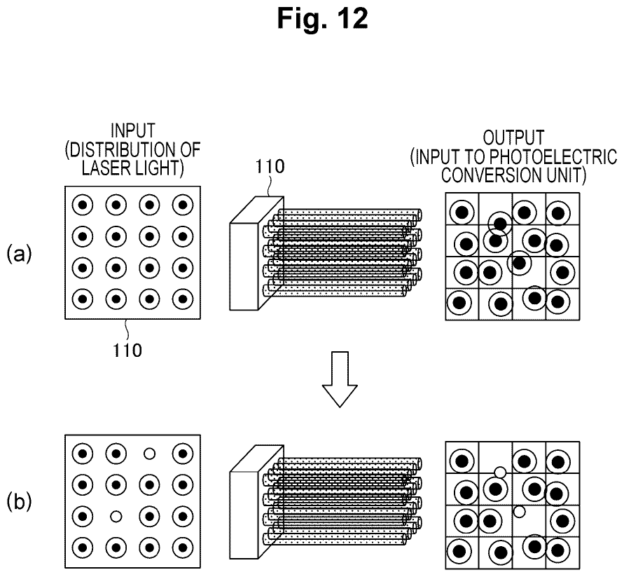

In FIG. 8 (and FIGS. 11 and 12), for convenience of illustration, the intensity distribution (Gaussian distribution) on the plane perpendicular to the optical axis of the laser light is indicated by a double circle consisting of a black circle and a white circle. In addition, in a case where the output is weakened, the intensity distribution is indicated only by a white circle.

As illustrated in FIG. 8, the arrangement of the lasers of the laser array is the same as the arrangement of the cells of the photoelectric conversion unit 210, and the lasers and the cells are both arranged in 4×4. With this arrangement, power of light emitted from the laser to each cell becomes uniform. It is assumed that the size of the light source unit 110 (laser array) arranged in 4×4 is the same as the size of the photoelectric conversion unit 210 arranged in 4×4. That is, for example, in a case where both have the shape illustrated in FIG. 6, the size of the entire square is the same in the light source unit 110 (laser array) and the photoelectric conversion unit 210.

However, the light source unit 110 (laser array) and the photoelectric conversion unit 210 having the same size are merely an example. The light source unit 110 (laser array) and the photoelectric conversion unit 210 may have different sizes.

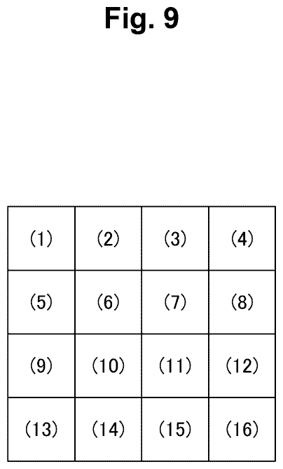

In the present embodiment, the cells in the photoelectric conversion unit 210 are numbered in the order as illustrated in FIG. 9. In the photoelectric conversion unit 210, the cells are connected in series in the order of this number. Note that this number is a number in a case where the light receiving surface of the photoelectric conversion unit 210 is viewed from the transmission apparatus 100 side.

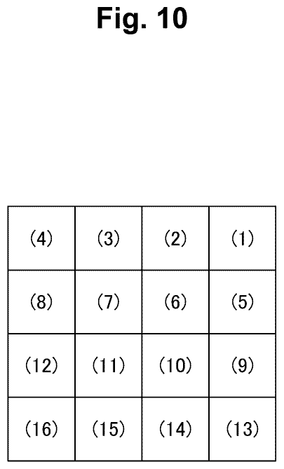

Each laser of the light source unit 110 (laser array) corresponding to each cell in FIG. 9 is as illustrated in FIG. 10. The numbers illustrated in FIG. 10 are numbers in a case where the light emitting surface of the light source unit 110 is viewed from the reception apparatus 200 side. The same numbers in FIGS. 9 and 10 indicate corresponding cells and lasers. For example, cell (1) of FIG. 9 corresponds to laser (1) of FIG. 10.

In addition, it is assumed that the light emitting surface of the light source unit 110 (laser array) and the light receiving surface of the photoelectric conversion unit 210 are parallel to each other and that their optical axes are aligned. That their optical axes are aligned means that, for example, a straight line extending perpendicularly to the light emitting surface from the center of the light emitting surface coincides with a straight line extending perpendicularly to the light receiving surface from the center of the light receiving surface. Note that even in a case where the optical axes are shifted by an error within a certain threshold value, it may be regarded that “their optical axes are aligned”. In addition, even in a case where the light emitting surface of the light source unit 110 and the light receiving surface of the photoelectric conversion unit 210 are shifted from parallel by an error within a certain threshold value, they may be regarded as “being parallel”.

As described above, “being parallel” and “their optical axes being aligned” are examples. The system may be configured such that the condition of “being parallel” or “their optical axes being aligned” is not required.

In the configuration of FIG. 8, laser light is output from each laser of the light source unit 110 toward the photoelectric conversion unit 210. At this time, the monitoring unit 310 of the control apparatus 300 monitors the voltage of each cell in the photoelectric conversion unit 210.

FIG. 11 illustrates an image of the light receiving surface (an image of a beam on the light receiving surface) in a case where there is a small atmospheric turbulence. As illustrated in FIG. 11, in a situation where the turbulence is small, the disturbance of the beam output from each laser is small. Therefore, each beam is shifted from the center of the corresponding cell, but falls within the cell, and light can be converted into power without wasting the transmitted power.

FIG. 12 illustrates an image of the light receiving surface in a case where there is a large atmospheric turbulence. In a situation where the turbulence is large, the position where each beam reaches the light receiving surface is shifted from the center of the cell due to beam wandering as illustrated in FIG. 12(a). Therefore, there are some cells where the beam is not contained (cells (2) and (11)). The voltage of such a cell drops significantly.

When detecting that there is a cell whose voltage has fallen below a reference value (it may be a cell whose voltage has become equal to or lower than a reference value), the control unit 320 of the control apparatus 300 disconnects the cell from serial connection. Further, the control unit 320 transmits the information (for example, information indicating that cells (2) and (11) have been disconnected) to the transmission apparatus 100, and reduces the output (output power) of the laser corresponding to the cell. FIG. 12(b) illustrates an image after the output is reduced.

More specifically, “the control unit 320 disconnects the cell from serial connection” means that the control unit 320 sends a control signal instructing to disconnect the cell from the serial connection to the reception apparatus 200, and the switching control unit 220 of the reception apparatus 200 disconnects the corresponding cell in the photoelectric conversion unit 210 from the serial connection on the basis of the control signal.

More specifically, “the control unit 320 reduces the output of the laser” means that the control unit 320 sends a control signal instructing to reduce the output of the laser to the transmission apparatus 100, and the light source control unit 110 of the transmission apparatus 100 reduces the output of the corresponding laser in the light source unit 110 on the basis of the control signal.

By disconnecting a cell whose voltage has fallen below a reference value from the serial connection, it is possible to prevent the current value of the entire photoelectric conversion unit 210 from being limited by the current value of the cell having a low power generation amount. Accordingly, the power generation amount of the entire photoelectric conversion unit 210 can be increased, the energy to be lost can be reduced, and the heat generation of the photoelectric conversion unit 210 can be suppressed.

After reducing the output of the laser corresponding to the cell whose voltage has fallen below the reference value, the control apparatus 300 monitors the voltage of the cell to monitor how the beam is disturbed with the minimum power. When detecting that the beam has returned into the cell again (that is, when detecting that the voltage has exceeded a certain reference value), the control apparatus 300 reconnects the cell to the serial connection, returns the output of the corresponding laser, and causes the cell to contribute to power generation. This makes it possible to follow a turbulence that changes from moment to moment and generate power with an optimal beam and cell connection.

In the above example, in a case where a predetermined condition on the voltage is satisfied, both “disconnecting the cell from the serial connection” and “reducing the output of the laser” are performed, but either “disconnecting the cell from the serial connection” or “reducing the output of the laser” need not be performed.

### Configuration Example of Photoelectric Conversion Unit 210

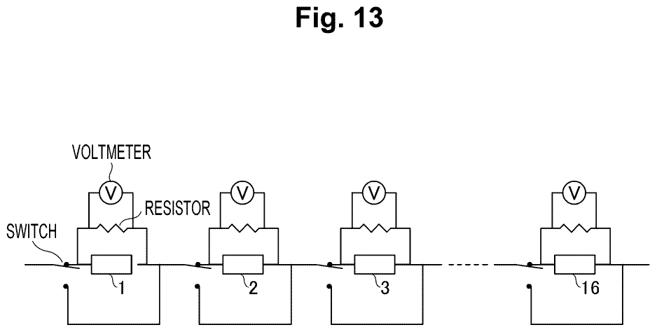

FIG. 13 illustrates an example of the circuit configuration of the photoelectric conversion unit 210. Cells (photoelectric conversion elements) are indicated by respective reference numerals 1 to 16. Reference numerals 1 to 16 correspond to the numbers (1) to (16) in FIG. 9.

Each cell is provided with a voltmeter and a resistor. The voltage of the cell is measured with a voltmeter. The magnitude of the resistance is made sufficiently large, and the loss of the current is suppressed. Each cell is provided with a switch. The cells can be connected in series or disconnected by a switch. The monitoring unit 310 of the control apparatus 300 can monitor the voltage measured by the voltmeter for each cell. The control unit 320 can control the switch.

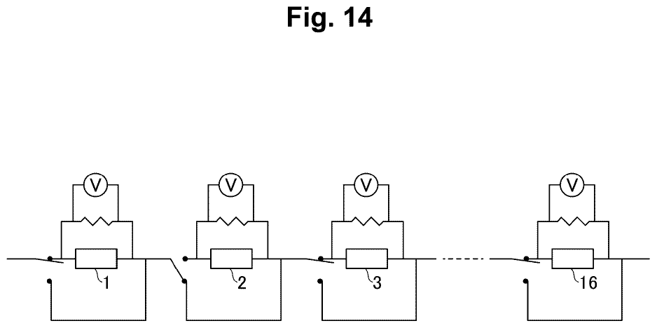

When each cell is sufficiently irradiated with light, all the cells are connected in series as illustrated in FIG. 13. When the turbulence increases and, for example, the voltage value of cell 2 falls below the reference value, as illustrated in FIG. 14, the switch of cell 2 is switched, and cell 2 is disconnected from the serial connection with other cells. As illustrated in FIG. 14, even when cell 2 is disconnected from the serial connection, cell 1 and cell 3 to 16 are connected in series.

At this time, although the output of the laser corresponding to cell 2 is reduced, since the laser is sending a beam, power generation is performed in cell 2, and the voltage of cell 2 can be continuously monitored. When the voltage value of cell 2 exceeds a certain reference value (or becomes equal to or greater than the reference value), the connection is returned to its original state as illustrated in FIG. 13.

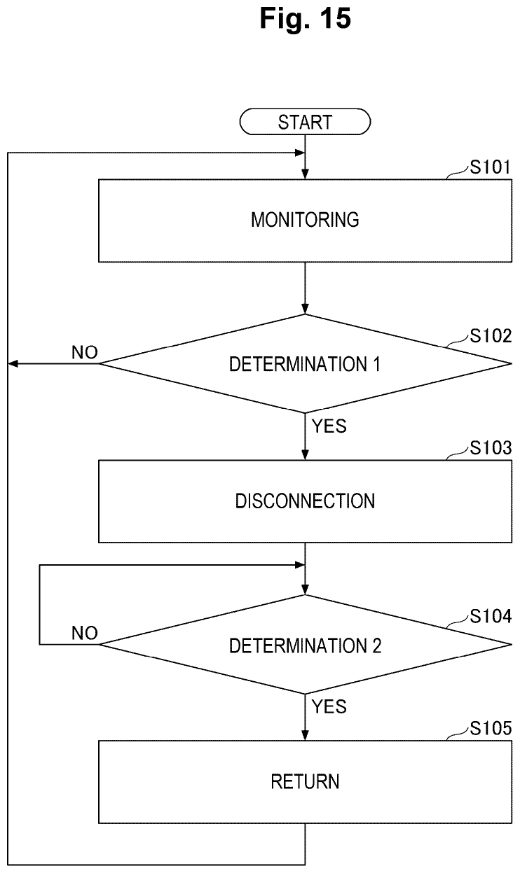

An example of the processing procedure of the control apparatus 300 for implementing the above operation will be described with reference to the flowchart of FIG. 15. Note that FIG. 5 illustrates a control flow focusing on one cell in order to facilitate understanding of the flow of processing. In practice, a plurality of cells is simultaneously monitored to perform control.

The monitoring unit 310 continuously monitors the voltage of each cell (S101). In S102, the control unit 320 determines whether or not there is a cell whose voltage value has become equal to or lower than a reference value A on the basis of the voltage value of each cell obtained by the monitoring unit 310 (this is referred to as Determination 1).

When detecting that there is a cell whose voltage value has become equal to or lower than the reference value A (Yes in Determination 1), the control unit 320 disconnects the cell from the serial connection in S103. In addition, the intensity of the output of the laser corresponding to the cell is reduced.

In S104, the control unit 320 determines whether or not the voltage value of the cell disconnected in S103 has become greater than a reference value B (Determination 2).

When detecting that the voltage value of the corresponding cell has become greater than the reference value B (Yes in Determination 2), the control unit 320 returns the cell to the serial connection in S105. Further, the output of the laser is returned to the normal output.

The reference value A and the reference value B may be the same, the reference value B may be a value smaller than the reference value A, or the reference value A may be a value smaller than the reference value B. In addition, both the reference value A and the reference value B may be different values for each cell.

### Specific Example of Method for Switching Switch

The method for switching the switch is not limited to a specific method, and for example, there are the following Method 1 and Method 2. Both Method 1 and Method 2 are examples of a method for disconnecting a photoelectric conversion element satisfying a predetermined condition for voltage from the serial connection.

### Method 1: Method for Extracting Maximum Voltage

First, Method 1 will be described. As long as the voltage value monitored in each cell does not fall below 0, a larger voltage can be obtained by connecting these cells in series.

Thus, in Method 1, the control apparatus 300 disconnects a cell whose voltage value falls below 0 for a cell whose voltage value is equal to or lower than 0) from the serial connection, and continues the serial connection for cells that are generating as much voltage as possible (for example, cells whose voltage values are greater than 0).

The control apparatus 300 monitors the voltage of the disconnected cell even after the cell is disconnected from the serial connection, and returns the cell to the serial connection when detecting that the voltage value has exceeded a certain reference value. The reference value here is, for example, a voltage value obtained when the cell is exposed to sufficient light, and is determined on the basis of the IV characteristic of the photoelectric conversion element.

According to Method 1, a voltage as large as possible can be extracted from the photoelectric conversion unit 210. In addition, by reducing the output of the laser sent to the cell disconnected from the serial connection, waste of power can be reduced.

### Method 2: Method for Increasing Power Generation Efficiency

Next, Method 2 will be described. In a case where a required voltage is determined in the power supply target, it is effective to control the connection of the cells to increase the power generation efficiency after securing the voltage.

In Method 2, the control apparatus 300 arranges the plurality of cells in the photoelectric conversion unit 210 in descending order of voltage, and adds the voltage values of the cells in descending order of voltage. Each time the voltage value is added, the control apparatus 300 determines whether the value of the addition result exceeds the required voltage, and when it is detected that the value of the addition result exceeds the required voltage, each cell after the cell for which the voltage addition was performed in the above arrangement is disconnected from the serial connection. In addition, the output of the laser corresponding to each cell disconnected from the serial connection is reduced.

In order to simplify the description, it is assumed that the voltages of cells 1 to 16 are high in order of their numbers. That is, it is assumed that the voltage of cell 1 is the highest and the voltage of cell 16 is the lowest. The control apparatus 300 repeats the calculation of adding the voltage value of cell 2 to the voltage value of cell 1 and adding the voltage value of cell 3 to the addition result, and when the sum of the voltage values of cells 1 to 10 exceeds the required voltage, disconnects cells 11 to 16 from the serial connection.

According to Method 2, it is possible to increase power generation efficiency and reduce power loss by disconnecting a cell having a low voltage from the serial connection while ensuring a required voltage.

### Hardware Configuration Example

The control apparatus 300 described in the present embodiment can be implemented, for example, by causing a computer to execute a program. This computer may be a physical computer, or may be a virtual machine on a cloud.

Specifically, the control apparatus 300 can be implemented by executing a program corresponding to the processing to be performed in the control apparatus 300, using hardware resources such as a CPU and a memory built into the computer. The above program can be stored and distributed by being recorded in a computer-readable recording medium (portable memory or the like). Furthermore, the program can also be provided through a network such as the Internet or an electronic mail.

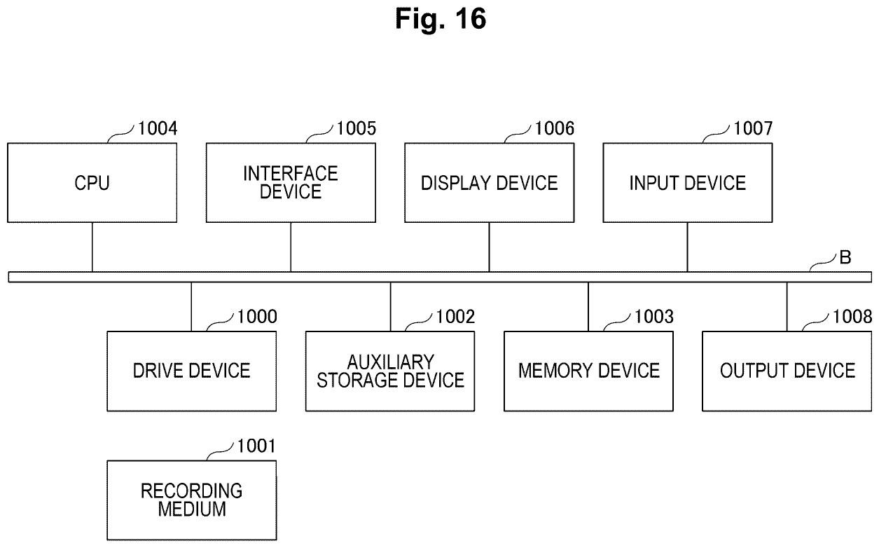

FIG. 16 is a diagram illustrating an example of a hardware configuration of the computer. The computer in FIG. 16 includes a drive device 1000, an auxiliary storage device 1002, a memory device 1003, a CPU 1004, an interface device 1005, a display device 1006, an input device 1007, an output device 1008, and the like, which are connected to each other by a bus BS. The computer may further include a GPU.

A program for implementing processing in the computer is provided by, for example, a recording medium 1001 such as a CD-ROM or a memory card. When the recording medium 1001 storing the program is set in the drive device 1000, the program is installed on the auxiliary storage device 1002 from the recording medium 1001 via the drive device 1000. Here, the program is not necessarily installed from the recording medium 1001 and may be downloaded from another computer via a network. The auxiliary storage device 1002 stores the installed program and also stores required files, data, and the like.

In a case where an instruction to start the program is made, the memory device 1003 reads the program from the auxiliary storage device 1002 and stores the program. The CPU 1004 implements a function related to the control device 300 in accordance with a program stored in the memory device 1003. The interface device 1005 is used as an interface for connecting to a network or the like. The display device 1006 displays a graphical user interface (GUI) or the like by the program. The input device 1007 includes a keyboard and a mouse, buttons, a touch panel, or the like, and is used to input various operation instructions. The output device 1008 outputs a calculation result.

### Summary of Embodiments, Effect, Etc.

As described above, in the optical wireless power supply system according to the present embodiment, it is possible to uniformly irradiate each of the cells connected in series with light by utilizing the laser array. Furthermore, for cells that are strongly affected by turbulence and are not irradiated with the beam, they can be disconnected from the serial connection to prevent them from contributing to power generation, and the output of the laser corresponding to those cells can be reduced, thereby ensuring the power generation amount and reducing power generation losses.

That is, according to the technology described in the present embodiment, it is possible to efficiently extract power from light in the optical wireless power supply technology.

More specifically, according to the technology described in the present embodiment, each cell can be irradiated with a beam more uniformly as compared with the related art, and light can be converted into power with high efficiency. Furthermore, by disconnecting cells that do not contribute to power generation or generate a small amount of power and reducing the output of the laser, the energy that becomes heat can be reduced, and deterioration of the characteristics of the photoelectric conversion element due to heat generation can be prevented.

In addition, according to Method 1 of disconnecting the cells in series, a voltage as large as possible can be obtained, and high-speed charging can also be achieved. In addition, according to Method 2, it is possible to ensure the required voltage and efficiently supply power without sending unnecessary power.

Regarding the above embodiment, the following clauses are further disclosed.

### Clauses

### Clause 1

An optical wireless power supply system including:
a light source unit including a plurality of light source elements; and
a photoelectric conversion unit including a plurality of photoelectric conversion elements,
in which a light emitting surface of the light source unit and a light receiving surface of the photoelectric conversion unit are arranged to face each other, and an arrangement of the plurality of photoelectric conversion elements on the light receiving surface is the same as an arrangement of the plurality of light source elements on the light emitting surface.

### Clause 2

The optical wireless power supply system according to Clause 1,
in which the plurality of photoelectric conversion elements constitutes a serial connection, and
a photoelectric conversion element that satisfies a predetermined condition for a voltage is disconnected from the serial connection.

### Clause 3

The optical wireless power supply system according to Clause 2,
in which an intensity of an output of a light source element corresponding to the photoelectric conversion element disconnected from the serial connection is reduced.

### Clause 4

A reception apparatus that is usable in an optical wireless power supply system, the reception apparatus including:
a photoelectric conversion unit including a plurality of photoelectric conversion elements,
in which, in a case where the reception apparatus is used in the optical wireless power supply system, a light emitting surface of a light source unit including a plurality of light source elements and a light receiving surface of the photoelectric conversion unit are arranged to face each other, and an arrangement of the plurality of photoelectric conversion elements on the light receiving surface is the same as an arrangement of the plurality of light source elements on the light emitting surface.

### Clause 5

A transmission apparatus that is usable in an optical wireless power supply system, the transmission apparatus including:
a light source unit including a plurality of light source elements,
in which, in a case where the transmission apparatus is used in the optical wireless power supply system, a light emitting surface of the light source unit and a light receiving surface of a photoelectric conversion unit including a plurality of photoelectric conversion elements are arranged to face each other, and an arrangement of the plurality of light source elements on the light emitting surface is the same as an arrangement of the plurality of photoelectric conversion elements on the light receiving surface.

### Clause 6

A control apparatus that controls an optical wireless power supply system including a light source unit including a plurality of light source elements and a photoelectric conversion unit including a plurality of photoelectric conversion elements constituting a serial connection, the control apparatus including:
a memory; and
at least one processor connected to the memory,
in which the processor is configured to:
monitor a voltage of each of the plurality of photoelectric conversion elements of the photoelectric conversion unit; and
disconnect a photoelectric conversion element that satisfies a predetermined condition for the voltage monitored by the monitoring unit from the serial connection.

### Clause 7

A control method executed by a control apparatus that controls an optical wireless power supply system including a light source unit including a plurality of light source elements and a photoelectric conversion unit including a plurality of photoelectric conversion elements constituting a serial connection, the control method including:
a monitoring step of monitoring a voltage of each of the plurality of photoelectric conversion elements of the photoelectric conversion unit; and
a control step of disconnecting a photoelectric conversion element that satisfies a predetermined condition for the voltage monitored in the monitoring step from the serial connection.

### Clause 8

A non-transitory storage medium storing a program for causing a computer to function as each unit in the control apparatus according to Clause 6.

Although the present embodiment has been described above, the present invention is not limited to such a specific embodiment, and various modifications and changes can be made within the scope of the gist of the present invention described in the claims.

### REFERENCE SIGNS LIST

100 Transmission apparatus
110 Light source unit
120 Light source control unit
200 Reception apparatus
210 Photoelectric conversion unit
220 Switching control unit
300 Control apparatus
310 Monitoring unit
320 Control unit
1000 Drive device
1001 Recording medium
1002 Auxiliary storage device
1003 Memory device
1004 CPU
1005 Interface device
1006 Display device
1007 Input device
1008 Output device

1. An optical wireless power supply system comprising:
a light source including a plurality of light source elements; and
a photoelectric converter including a plurality of photoelectric conversion elements,
wherein a light emitting surface of the light source and a light receiving surface of the photoelectric converter are arranged to face each other, and an arrangement of the plurality of photoelectric conversion elements on the light receiving surface is the same as an arrangement of the plurality of light source elements on the light emitting surface.

2. The optical wireless power supply system according to claim 1,
wherein the plurality of photoelectric conversion elements constitutes a serial connection, and
a photoelectric conversion element that satisfies a predetermined condition for a voltage is disconnected from the serial connection.

3. The optical wireless power supply system according to claim 2,
wherein an intensity of an output of a light source element corresponding to the photoelectric conversion element disconnected from the serial connection is reduced.

4. A reception apparatus that is usable in an optical wireless power supply system, the reception apparatus comprising:
a photoelectric converter including a plurality of photoelectric conversion elements,
wherein, in a case where the reception apparatus is used in the optical wireless power supply system, a light emitting surface of a light source including a plurality of light source elements and a light receiving surface of the photoelectric converter are arranged to face each other, and an arrangement of the plurality of photoelectric conversion elements on the light receiving surface is the same as an arrangement of the plurality of light source elements on the light emitting surface.

5. A transmission apparatus that is usable in an optical wireless power supply system, the transmission apparatus comprising:
a light source including a plurality of light source elements,
wherein, in a case where the transmission apparatus is used in the optical wireless power supply system, a light emitting surface of the light source and a light receiving surface of a photoelectric converter including a plurality of photoelectric conversion elements are arranged to face each other, and an arrangement of the plurality of light source elements on the light emitting surface is the same as an arrangement of the plurality of photoelectric conversion elements on the light receiving surface.

6. (canceled)

7. (canceled)

8. A non-transitory computer-readable recording medium having computer-readable instructions stored thereon, which when executed, causes a computer including a memory and a processor to function as the optical wireless power supply system of claim 1.
